(19) United States
(12) Patent Application Publication
(10) Pub. No.: US 2003/0196000 A1
(43) Pub. Date: Oct. 16, 2003

(54) Data transmission method

(76) Inventor: Bjoern Magnussen, Iserlohn (DE)

Correspondence Address: STAAS & HALSEY LLP, SUITE 700, 1201 NEW YORK AVENUE, N.W., WASHINGTON, DC, 20005, US

(21) Appl. No.: 10/333,247

(22) PCT Filed: Jul. 16, 2001
(86) PCT No.: PCT/DE01/02658

(30) Foreign Application Priority Data
Jul. 17, 2000 (DE) 100 34 693.6

(51) Int. Cl. G06F 3/00

(52) U.S. Cl. 710/1

(57) ABSTRACT

According to the invention, data of several sensors (PIC1, PIC2) is transmitted to a control device (1) via a data bus (6), whereby a data relevance value is established in the sensor (PIC1, PIC2). Said data relevance value of the sensor (PIC1, PIC2) is stored on the bus (6) and only one single largest value of at least sensor (PIC1, PIC2) is transmitted to the control device (1).

The invention relates to a method for transmitting data from a number of sensors to a control device, which method is used, for example, in robotics. In this case, data from sensors, for example collision sensors, tactile sensors or contact sensors, is transmitted as a control device for a robot, providing information as to whether the robot has come into contact with an object.

Since a collision generally represents an event which should be avoided by the normal sense of the robot, such a collision report represents an important, safety-relevant item of information whose rapid transmission is desirable. Particularly when using a robot in the area around people, rapid, reliable and safe transmission has priority, for safety reasons.

Furthermore, it may be important to know the precise location or point at which the collision has occurred. For this reason, robots often have a very large number of sensors, in which case, disadvantageously, reliable, safe and rapid transmission is ensured only by incurring high costs.

In this case, both the costs for the microcontrollers which are normally used in the sensors as well as the costs for the transmitting and receiving device for the sensors and possibly also for the control device, that is to say the device for switching on the communications lines, which are normally available in the form of driver modules, must also be included. For this reason, most known systems make use of cost-effective driver modules for the microcontrollers, with each sensor being connected individually to the control unit, in order to ensure reliable, safe and rapid transmission of the sensor data.

As an alternative, the sensors can be connected to the control device via a bus system, although bus systems such as these are scarcely used in practice since the high-speed requirements mean that many expensive access assemblies must be used, so that this solution is disadvantageously too costly for use in large-scale operation.

The present invention is therefore based on the object of providing a method and a circuit arrangement for this purpose, for transmitting data from a number of sensors to a control device, which method ensures reliable, safe and rapid transmission of information relating to an event that has occurred, for example a collision.

According to the invention, this object is achieved by a method having the features of claim 1 and by a circuit arrangement having the features of claim 5.

According to the invention, both cost-effective transmitting and receiving devices, that is to say access assemblies such as driver modules and the like, as well as sensors with cost-effective microcontrollers are used and, in addition, complicated and costly wiring by means of individual lines is avoided.

The use of the method according to the invention also makes it possible to use a cost-effective, slower bus system instead of a high-speed, costly bus system. In this case, the transmission of the most relevant information which is passed through on the bus with priority over less relevant information ensures that this information is available with sufficient speed, reliability and safety in the control device, and that corresponding reactions can be initiated.

In one preferred embodiment of the invention, the data bus is in the form of a single logic data line, via which all the sensors both at the receiving end and at the transmitting end communicate with the control device. This logical single data line can advantageously physically be in the form of a two-line system, with the difference voltage between the two lines acting as a logic data line, so that this refinement advantageously makes it possible to ensure data transmission with high interference immunity.

In one advantageous embodiment of the invention, the sensors start to apply their respective data relevance value, for example the detected pressure value of a collision to the bus in synchronism with one another via their transmitting output and an access assembly. The sensors at the same time listen, at their receiving inputs, to the appropriate signals on the bus.

This synchronization can, of course, be carried out by means of appropriate protocols, for example a start bit and in particular a negative clock edge which is detected by all the sensors which are monitoring the bus, or can be carried out by means of the control device, for example in the form of a PC, which produces a specific control bit or signal on the bus.

In one preferred embodiment of the invention, the sensors start to apply their respective data relevance value to the bus only on request from the control device, that is to say on receiving a specific signal or signal sequence, for example a byte with specific information.

On the bus, which in one preferred embodiment of the invention is in the form of a “0”-dominant bus, each sensor sends its data relevance value, for example in the form of one byte, until it detects a “0” on the bus at the receiving end, and applies a value other than this at the transmitting end, that is to say a “1”. On the basis of this principle, the sensors with little relevant data are switched off successively until one or more sensors with the same highest relevant value remain.

If the values in the sensors are coded in positive binary form, for example as one byte and the bus is designed to be “0”-dominant, these values must be inverted in order to pass through the most relevant value. It is, of course, also feasible to store the data relevance values using negative coding in the sensors or in the microcontrollers, or to use a bus system with a “1”-dominant behavior.

Once the data relevance value has been transmitted, it is possible, in order to find the location or the point of a collision in an advantageous manner, to transmit the further information, for example as the next byte, a unique ID for the sensor or sensors having the most relevant value to the PC, in which case, in order to establish an individual sensor with the most importance, the ID values may be transmitted on the basis of the same principle as that described above for the data relevance value. For this purpose, the ID values are advantageously associated with the sensors in a decreasing or increasing sequence based on the importance of the location at which the sensors are located, so that the most important ID value and hence the most relevant location with the most relevant pressure value once again passes through the bus and is transmitted to the control device.

This advantageously makes it possible, despite the use of very low-cost electronic components and low-cost wiring, to transmit the important event, for example the most relevant pressure in the event of a collision, to a control device rapidly, reliably and safely.

In a further refinement of the invention, some or all of the pressure values of the sensors can be transmitted in the sequence of the relevance to the control device, with the sensor which in each case has the highest data relevance value being switched off after it has transmitted to the control device, for example by setting its data relevance value to “0” and by repeating the preceding steps for transmitting the data relevance values of the other sensors.

This may be done repeatedly as a function of a threshold value which can be determined in advance on the PC until the data transmission or the checking of the sensors is stopped when this threshold value is undershot, and with it also being possible to check all the sensors if the threshold value has been set to “0”.

If another collision occurs, the sensors or their microcontrollers can then autonomously overwrite the values that they have themselves set to “0” with the newly detected value, in which case it is also feasible for the sensors and/or their values to be reset by transmitting a specific signal, for example a specific byte, from the control device to the sensors.

In one particular refinement of the invention, the control unit can check the accessibility of the sensor via the bus, for example at regular intervals or on request, with the sensors in this case applying a data item, for example their self-test signal, to the bus on request by the control device, and with this data item then being evaluated by the control unit. This makes it possible to completely automatically identify faults such as defective sensors or faults in the transmission path, as well as to localize them by transmitting a value which is unique for each sensor.

It is, of course, feasible for the sensors and/or the microcontrollers to produce data relevance values as a function of the intensity of a collision at the location of this sensor and as a function of specific relevance parameters of a linear or non-linear nature, in order as optimally as possible to match the importance of the pressure intensity in the event of a collision at specific locations to the appropriate requirements, such as the inclusion of a different sensitivity for different locations, or the like.

Further advantageous refinements of the invention can be found in the dependent claims.

The invention will be explained in the following text with reference to an exemplary embodiment which is illustrated in the drawing, in which:

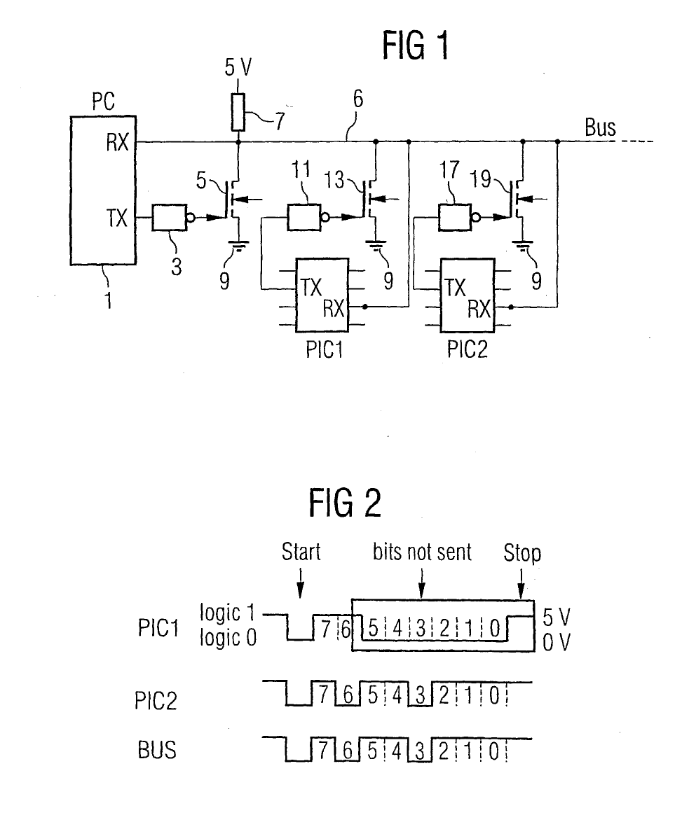

FIG. 1 shows an outline circuit diagram of a circuit arrangement according to the invention, and

FIG. 2 shows a diagram of a communications protocol for a circuit arrangement as shown in FIG. 1.

The outline circuit diagram in FIG. 1 shows how two sensors PIC 1 and PIC 2 communicate with a control device 1, for example in the form of a PC, via a bus 6. Further sensors in the form illustrated for PIC 1 and PIC 2 may, of course, be connected to this bus 6, although the operation and the interaction of the sensors PIC 1 and PIC 2 with the control arrangement 1 will be described in the following text, in order to explain the circuit arrangement and the transmission method.

In the outline circuit diagram shown in FIG. 1, the bus 6 is illustrated as a logic data line, although this logic data line may, of course also be physically implemented in different embodiments, for example as a single-wire line with a voltage difference with respect to ground, as a two-wire line with a voltage difference between the two lines, or as a CAN bus etc.

The circuit arrangement shown in FIG. 1 may, for example, be used for a robot, in order to allow communication between its sensors PIC 1, PIC 2, for example contact collision or tactile sensors, and its control device 1, for example in the form of a PC.

As illustrated in the outline circuit diagram, the receiving inputs RX of the control device 1 and of the sensors PIC 1 and PIC 2 are connected directly to the bus 6, which is connected to a power supply (for example 5 volts) via a resistor 7.

The transmitting outputs TX of the control device 1 and of the sensors PIC 1 and PIC 2 in this case access the bus via access assemblies 3;5, 11;13 and 17;19. These access assemblies each have a transistor (5, 13, 19), for example a MOSFET, whose control input, for example its gate, is connected via a respective inverter 3, 11, 17 to the transmitting output TX of the control device 1 or of the sensors PIC 1, PIC 2.

The inversion by the inverters 3, 11 ands 17 is in this case intended to make it possible for a logic “1” likewise to be applied to the bus 6 when a positive signal is produced at the output TX, that is to say a logic “1”. This is necessary in the exemplary embodiments since the illustrated transistor circuit comprising the transistors 5, 13, 19 is switched on when a logic “1” is applied to its control input, for example its gate or base, with the switched-on path passing between the gate and the source or between the collector and the emitter, so that the bus 6 is in this way drawn to ground 9, that is to say the logic “0”.

In order to cancel this inversion in the path of the transistors 5, 13 and 19 and their wiring, a respective inverter 3, 11 or 17 is connected upstream of the control input of the respective transistors 5, 13 and 19, so that this double negation cancels out the negation of the transistors 5, 13 and 19, so that the same signal is produced on the bus 6 as at the output TX of the control device 1 or of the sensors PIC 1 and PIC 2.

This principle of the access assemblies 3;5 or 11;13 or 17;19 is, of course, only an example for known driver modules which can be used both at the transmitting end (TX) and at the receiving end (RX).

The illustrated outline circuit diagram shows that the bus is in this case a “0”-dominant bus, that is to say a bus on which a logic “0” or low level passes through in contrast to a logic high or a logic “1”, since the entire bus is drawn to this low level by means of a single connection to ground 9.

Furthermore, the control device 1 follows the sensors PIC 1 and PIC 2, which normally each have a microcontroller, are connected by their receiving inputs RX at the receiving end to the bus 6, so that the respective state of the bus 6 is received and detected not only by the control device 1 but also by the sensors PIC 1 and PIC 2.

This means that it is possible not only for the control device 1 and the sensors PIC 1 or PIC 2 to receive a transmitted signal, for example a logic “0”, at both ends, but also for a sensor, for example PIC 1 or PIC 2, to receive the signal from the sensor or from the other sensors, for example PIC 2 or PIC 1. This means, for example, that it is possible for a sensor PIC 1 or PIC 2 to determine whether any other sensors PIC 2 or PIC 1 is applying a logic “0” to the bus 6.

The operation of the circuit arrangement as shown in FIG. 1 will be explained in the following text with reference to the communications protocol illustrated in FIG. 2.

If the sensors PIC 1 and PIC 2 intend to transmit the events registered there, or their values, for example a pressure value for a collision of a robot, to the control device 1, the data item from a sensor, which by way of example is stored in the register of a microcontroller in the sensor, is in this case applied to the bus 6 via the respective access group 11;13 or 17;19.

Since the sensors PIC 1 and PIC 2 contain pressure values for a collision, and the most relevant value, that is to say the highest pressure, is intended to be passed through, the values or pressure values contained in the sensors are negated, for example in the microcontroller, before being transmitted, or, in the event of a one-byte transmission, are logically linked by an FF (binary 1111 1111) EXOR.

For a pressure value 63 (decimal) from the sensor PIC 1, which in binary form corresponds to 0011 1111, by way of example, this results in the negated value 1100 0000 as illustrated as the square-wave signal in the topmost line in FIG. 1. The pressure value 72 (decimal) from the sensor PIC 2, which corresponds to 0100 1000 in binary form, thus becomes 1011 0111, as illustrated as a square-wave signal in the center line in FIG. 1.

After a start signal (a logic “0”, or a negative or positive clock edge), for example, is used for synchronization of the transmission of the information from the sensors PIC 1 and PIC 2 to the control device 1, the respective pressure value from a sensor PIC 1 and PIC 2 is then applied to the bus 6 at the same time, bit-by-bit, in the sequence 7-6-5-4-3-2-1-0.

Since, as already mentioned, the bus 6 is “0”-dominant, a logic “0” from a sensor PIC 1 or PIC 2 is passed through, so that the first logic “0” is passed through to the bus 6, like the bit 6 from the sensor PIC 2 in the example. This logic “0” is detected not only by the control device 1 but also by the other sensors PIC 2, or by further other sensors connected to the bus, via their receiving inputs RX.

If this value (logic “0”) differs from the bit value sent for this type at the output TX of a respective sensor, then this sensor stops transmitting. The logic of this type for detecting such a “0” situation at the input RX and for detecting a value that differs from this at the output TX can be provided, by way of example, via a gate or in the form of a microprogram in a microcontroller. In the example shown in FIG. 2, the sensor PIC 1 accordingly stops transmitting, although this is not evident from the program since, in order to assist understanding in the diagram, the pressure values which are stored in the sensors PIC 1 and PIC 2 are illustrated in logic form, and not the signal which is produced at the outputs TX and on the bus 6.

Once the sensor PIC 1 has stopped transmitting during the transmission of the bit 6, the subsequent bits 5 to 0 from the sensor PIC 2 can be transmitted independently of the value contained in the sensor PIC 1, via the bus 6 to the control device 1, or to its input RX.

In consequence, the highest value, that is to say the most relevant value, from one or more sensors, is also passed through for a circuit arrangement having any desired number of sensors. In this case, it is feasible for the highest value to occur in an identical form in a number of sensors so that, although it is possible to make a statement on the highest value or the most relevant value which, according to the invention, is transmitted rapidly, reliably and safely to the control device 1, it is not possible to determine the sensor or sensors in which this value is present. The location or the point of occurrence of such a value is accordingly not known at this time.

However, this can be done in a simple manner by transmitting an ID value which is unique for one sensor, for example once again in the form of a byte, following the transmission of a pressure value for which, as indicated above for the highest pressure value, only one specific ID value, for example the highest ID value is likewise passed through.

After this transmission, which can likewise be synchronized once again by means of the start bit, the control device 1 then knows not only the most relevant value but also the location or the point of its occurrence. For this purpose, the checking of an ID or an overall check of the “pressure value and ID” can be repeated until no more sensors transmit.

In this case, it is necessary for a sensor with the respectively highest value ID and thus once again the most relevant value to switch off after transmitting its value to the control device 1, and no longer to transmit in response to further ID checks.

This may be done, for example, by the sensor PIC 2 whose data relevance value and ID have been transmitted to the control device 1 setting its data relevance value to the lowest value (for example 0000 0000 and hence 1111 1111 inverted). In consequence, this sensor is reliably and safely passed over when the next check occurs for data in the data relevance value and thus for its capability to be passed through on the bus, so that the next-higher value (from another sensor PIC 1) is passed through and reaches the control device 1. In this case, by using its receiving input RX, a sensor can permanently monitor the bus 6 to check that its data relevance value (DR value) and if appropriate ID value have been successfully passed through and successfully transmitted, so that this sensor knows (or the subsequent switching off and zeroing of the register) that it is the only one which has been passed through on the bus 6 with respect to the other sensors.

This will be explained in more detail using the following example with three sensors connected to the bus 6 and synchronous transmission:

| First check by the control system 1: | | | | |
|---|---|---|---|---|
| Sensor 1: | | | | |
| DR | value:0000 | 0110 | inverted:1111 | 1001 |
| | | | transmitted:1111 | 1001 |
| ID | value:0000 | 0101 | inverted:1111 | 1010 |
| | | | transmitted:1111 | 1010 |

This sensor is passed through on the bus 6 during transmission. The values on the bus 6 correspond to those which the sensor wishes to transmit. The sensor therefore knows that it was the “winner” for this transmission. After this transmission, this sensor sets its data relevance value (DR value) to 0000 0000.

| Sensor 2: | | | | |
|---|---|---|---|---|
| DR | value:0000 | 0101 | inverted:1111 | 1010 |
| | | | transmitted:1111 | 1011 |
| ID | value:0000 | 0110 | inverted:1111 | 1001 |
| | | | transmitted:1111 | 1111 |

This sensor notes that its DR value was too low. It withdraws itself from the bus 6 from bit 1 (second digit from the right, see sensor 1) of the DR value and now transmits only “1” (or 11 . . . ), in particular for the entire ID value.

| Sensor 3: | | | | |
|---|---|---|---|---|
| DR | value:0000 | 0101 | inverted:1111 | 1010 |
| | | | transmitted:1111 | 1011 |
| ID | value:0000 | 0100 | inverted:1111 | 1011 |
| | | | transmitted:1111 | 1111 |

This sensor notes that its DR value was too low. It withdraws itself from the bus 6 from bit 1 of the DR value and now transmits only “1”, in particular for the entire ID value.

Values received at the PC or at the control device 1:

DR value:1111 1001 inverted:0000 0110=pressure value of sensor 1

ID value:1111 1010 inverted:0000 0101=ID value of the sensor 1.

Check of the second most relevant value:

| Sensor 1: | | | | |
|---|---|---|---|---|
| DR | value:0000 | 0000 | inverted:1111 | 1111 |
| | | | transmitted:1111 | 1111 |
| ID | value:0000 | 0101 | inverted:1111 | 1010 |
| | | | transmitted:1111 | 1111 |

This sensor notes that its (reset) DR value was too low. It withdraws itself from the bus 6 from the bit 2 (third digit from the right, see sensors 2 and 3) of the DR value and now transmits only “1”, in particular for the entire ID value.

| Sensor 2: | | | | |
|---|---|---|---|---|
| DR | value:0000 | 0101 | inverted:1111 | 1010 |
| | | | transmitted:1111 | 1010 |
| ID | value:0000 | 0110 | inverted:1111 | 1001 |
| | | | transmitted:1111 | 1001 |

This sensor is passed through during transmission on the bus 6. The values on the bus 6 correspond to those which the sensor wish to transmit. The sensor therefore knows that it was the “winner” for this transmission. After this transmission, this sensor sets its data relevance value (DR value) to 0000 0000.

| Sensor 3: | | | | |
|---|---|---|---|---|
| DR | value:0000 | 0101 | inverted:1111 | 1010 |
| | | | transmitted:1111 | 1010 |
| ID | value:0000 | 0100 | inverted:1111 | 1011 |
| | | | transmitted:1111 | 1011 |

This sensor notes that its DR value was high enough to be transmitted successfully. It thus knows that no other sensor has a higher data relevance. However, despite this, it is possible for another sensor to have the same DR value (as in this example) . In order to resolve the situation, the ID value is transmitted. In this case, this sensor finds that another sensor with the same DR value has an ID which is passed through to a greater extent. This sensor therefore withdraws itself from the bus 6 from bit 1 of the ID, and now transmits only “1”.

Values received at the PC and at the control device 1:

DR value:1111 1010 inverted:0000 0101=pressure value of sensor 2

ID value:1111 1001 inverted:0000 0110=ID value of the sensor 2.

Check of the third most relevant value:

| Sensor 1: | | | | |
|---|---|---|---|---|
| DR | value:0000 | 0000 | inverted:1112 | 1111 |
| | | | transmitted:1111 | 1111 |
| ID | value:0000 | 0101 | inverted:1111 | 1010 |
| | | | transmitted:1111 | 1111 |

This sensor notes that its (reset) DR value was too low. It withdraws itself from the bus 6 from bit 2 (third digit from the right, see sensor 3) of the DR value and now transmits only “1” in particular for the entire ID value.

| Sensor 2: | | | | |
|---|---|---|---|---|
| DR | value:0000 | 0000 | inverted:1111 | 1111 |
| | | | transmitted:1111 | 1111 |
| ID | value:0000 | 0110 | inverted:1111 | 1001 |

transmitted:1111 1111

This sensor notes that its (reset) DR value was too low. It withdraws itself from the bus 6 from bit 2 (third digit from the right, see sensor 3) of the DR value and now transmits only “1” in particular for the entire ID value.

| Sensor 3: | | | | |
|---|---|---|---|---|
| DR | value:0000 | 0101 | inverted:1111 | 1010 |
| | | | transmitted:1111 | 1010 |
| ID | value:0000 | 0100 | inverted:1111 | 1011 |
| | | | transmitted:1111 | 1011 |

This sensor is passed through on the bus 6 during transmission. The values on the bus 6 correspond to those which the sensor wished to transmit. The sensor thus knows that it was the “winner” for this transmission. After this transmission, this sensor sets its data relevance value (DR value) to 0000 0000.

Values received at the PC and at the control device 1:

DR value:1111 1010 inverted:0000 0101=pressure value of sensor 3

ID value:1111 1011 inverted:0000 0100=ID value of the sensor 3.

Check of the fourth most relevant value:

| Sensor 4: | | | | |
|---|---|---|---|---|
| DR | value:0000 | 0000 | inverted:1111 | 1111 |
| | | | transmitted:1111 | 1111 |
| ID | value:0000 | 0101 | inverted:1111 | 1010 |
| | | | transmitted:1111 | 1011 |

All the sensors know that they have the highest possible DR value, but do not know how many other sensors have the same value. When the IDs are transmitted, the sensor with the strongest ID is passed through. From bit 1 of the ID, this sensor identifies the fact that another sensor is stronger (or has a stronger ID) and from this point now transmits only “1”.

| Sensor 2: | | | | |
|---|---|---|---|---|
| DR | value:0000 | 0000 | inverted:1111 | 1111 |
| | | | transmitted:1111 | 1111 |
| ID | value:0000 | 0110 | inverted:1111 | 1001 |
| | | | transmitted:1111 | 1001 |

All the sensors know that they have the highest possible DR value, but do not know how many other sensors have the same value. When the IDs are transmitted, the sensor with the strongest ID is passed through. This sensor identifies that its ID has been passed through on the bus.

| Sensor 3: | | | | |
|---|---|---|---|---|
| DR | value:0000 | 0000 | inverted:1111 | 1111 |
| | | | transmitted:1111 | 1111 |
| ID | value:0000 | 0100 | inverted:1111 | 1011 |
| | | | transmitted:1111 | 1011 |

All the sensors know that they have the highest possible DR value, but do not know how many other sensors have the same value. When the IDs are transmitted, the sensor with the strongest ID is passed through. This sensor identifies from bit 1 of the ID that another sensor is stronger (or has a stronger ID) and from there now transmits only “1”.

Values received at the PC and at the control device 1:

DR value:1111 1111 inverted:0000 0000=minimum DR value

ID value: 1111 1001 inverted:0000 0110=ID value of the sensor 2.

The PC identifies that the ID of the sensor 2 has now been transmitted for the second time. This means that all the sensors have been read. This can also be identified from the data relevance value, since the lowest possible DR value (0000 0000) must not be the result of a pressure measurement. In order to make this evident, it is possible always to add a “1” to each measured pressure for this purpose, for example.

The IDs may in this case be transmitted in the same way as the pressure values on request by the control device 1, for example by transmitting a start signal in the form of a bit, negative or positive clock edge, specific byte or the like.

However, it is also feasible for the sensors PIC 1 PIC 2 etc to start to transmit autonomously as soon as at least one sensor PIC 1, PIC 2 detects a collision, and to apply to the bus 6 a negative clock edge or a low level signal which is detected by the other sensors as a start bit, so that all the sensors PIC 1, PIC 2 etc. which are connected to the bus 6 start to transmit their pressure values that they contain, synchronously and at the same time. It is, of course, also feasible for only those sensors which actually detect a collision to start to transmit.

In one preferred embodiment of the invention, the ID transmission takes place without renewed synchronization, with the synchronization being used for DR value and pressure value transmission, and a fixed time delay occurring before the start of the ID transmission. The sensors PIC 1, PIC 2 typically measure the time of the start bit (Ts) which is transmitted, by way of example, by the control device 1, for example of a first transmitted byte, and respond with (simultaneous) transmission, synchronized in this way, of the DR values at a fixed time after this (Ts+T1). From then on, the sensors PIC 1, PIC 2 require no further synchronization and transmit their ID value with a fixed delay (Ts+T1+T2). In consequence, there is not necessarily any need for renewed synchronization between the transmission of the DR values and the transmission of the ID values. However, if the timebase for the sensors is poor, the sensors may wait for a defined time and then start to send a start bit, in order to synchronize the transmission of the ID values. In this case, the waiting process while the sensors are listening to the bus 6 for the occurrence of start bits can be terminated, with (renewed) synchronization being achieved in this way.

IT is advantageously possible to use low-cost, commercially available components (for example the RS485 or CAN drivers from Philips as mass produced items) for the rapid data transmission according to the invention between the sensors PIC 1, PIC 2 and the control device 1.

The data can be transmitted using the known advantageously RS232 Standard, in which case it is possible to use a low-cost bus system with only one logic data line and low-cost conventional access assemblies and bus driver modules, in order to connect a number of sensors, which are connected to a bus, to the control device 1 using, for example, a wired-AND principle. In particular, a conventional RS232 protocol may be used as the data protocol at the control device 1 end, so that this system can advantageously be connected to a large number of existing PCs or other equipment using RS232, without any protocol converter (but possibly with a level converter).

It is likewise possible to use low-cost sensors, for example with a microcontroller, for this circuit arrangement, since the principle according to the invention, in which the most relevant value is passed through the bus first and on its own and is thus transmitted to the control device 1, allows adequate speed, reliability and safety to be ensured despite the low-cost implementation of the circuit arrangement.

Further functions such as resetting of the sensors, for example of the registers in the microcontrollers, calibration of the sensors PIC 1 and PIC 2, etc. can also be implemented, of course, in this system with very little cabling complexity and very low-cost electronic modules.

For example, it is possible on request by the control device 1, for example by transmitting a specific byte (which, of course, is not the same as the request byte) to initiate resetting of the sensors PIC 1, PIC 2, and, by transmitting another specific byte, to initiate a calibration process (for example for the timebase and/or the sensor sensitivity or the mathematical function which is used to calculate a pressure value in the sensor), or the like.

It is also feasible, for example, to carry out a test for the serviceability of the entire system, during which the pressure values and/or the unique ID values can be transmitted to the control device 1 without any collision occurring, in this way making it possible to check the serviceability of all the sensors PIC, PIC 2, etc., and of the transmission path.

In order to match the values of the sensors PIC 1, PIC 2 to the respective application as optimally as possible, it is also feasible to distribute not only the ID values on the basis of the relevance of the locations or positions of the sensors, for example in a descending manner, but also to couple a fixed collision value in a sensor PIC 1, PIC 2 etc., to an adjustable relevance value in a linear or non-linear function, so that a pressure value for a collision is produced as a function of this relevance value and of the function as well as of the actual sensor value, which is then transmitted to the control device 1.

According to the invention, it is also feasible to address certain sensors specifically by transmitting the ID of that sensor. In this case, the control device 1 first of all sends a command (for example “send your own information”), and then the ID of the desired sensor, while none of the other sensors are involved in this transmission.

Furthermore, a “self-mode” can be integrated in the arrangement and in the method, in which the sensors send a break signal (for example using the RS232 protocol), which is dominant over all the other transmissions, when a specific event occurs (for example 0 0000 0000 0000 0000). In this case, each sensor may be equipped with a reaction threshold which can be set by the control device 1. If the reaction threshold (data relevance threshold) is exceeded in a sensor once the sensors have been switched to the “self-signaling mode”, then the sensor itself sets, for example, 0000 0000 (without being requested by the control device 1). Even if a number of sensors transmit at the same time, this once again results either in 0000 0000 or a longer period, which can likewise be identified by the control device 1 (for example a break signal in accordance with a RS232 protocol). When sensors receive 0000 0000 via their receiving input RX, then they return to the normal communications mode, as described above. In consequence, there is no need for the control device 1 to continually check the value (for example the collision pressure) of the sensor or of all the connected sensors, and, instead, it can wait until a signal arrives at the serial interface (RS232). If the control device 1 has received such a signal, then it uses the method described above to check which is the strongest or more relevant pressure value. In this case, it is also possible for the control device 1 to terminate this “self-signaling mode” prematurely by, for example, itself transmitting 0000 0000.

It is also feasible for a sensor which has not checked a specific time period which can be predetermined to make itself known by relatively long zero periods. This signal is then received as a break signal by the control device 1, irrespective of any other processes.

The method which has been described above for a robot and collisions ensures that the principle according to the invention of transmission of data as a function of their relevance and with a cost-effective implementation that at least the most relevant value or values are available with sufficient speed, reliability and safety in the control device 1 for further processing.

The method according to the invention as well as the circuit arrangement are not, of course, restricted to the described exemplary embodiment but can be used in widely differing fields of application in which objects carry out movements relative to one another, distances are intended to be detected, collisions are intended to be avoided or else, in the case of stationary systems such as sensors for measuring earthquakes, wind speeds, etc and transmission of this data to central control devices.

In this case, the concurrency as described above of the relative importance or relevance of the data of the sensors, and the most relevant value of the transmitting sensors or sensors which are connected to the bus being passed on (as a function of this concurrency and in consequence dynamically) means that this information is available more quickly than in conventional systems, so that it is advantageously also possible to use slower, simpler and more cost-effective systems for transmission (bus systems, access assemblies, sensors etc.). In this case, for the purposes of the invention, the word sensors should be understood as having a very far-reaching meaning, and the word is also intended to cover, for example, input devices having at least one receiving input RX and at least one transmitting output TX.

In this case, it should be expressly mentioned that, according to the invention, the strongest data relevance value of all the sensors which are connected to the bus is passed through during the synchronous and simultaneous transmission of the (sensor) values, and that this data relevance value contains the data value, or the data relevance value depends on the data value and a parameter function. The relevance or priority for the transmission is thus dependent on the data itself which, according to the invention, should be understood as meaning variable or dynamic relevance or priority of the data.

1. A method for transmitting data from a number of sensors (PIC 1, PIC 2) to a control device (1) via a data bus (6), with
a) a data relevance value being determined in the sensor (PIC 1, PIC 2),
b) the data relevance value of the sensor (PIC 1, PIC 2) being applied to the bus (6), and
c) only the greatest data relevance value from the sensors (PIC 1, PIC 2) being transmitted to the control device (1).

2. The method as claimed in claim 1, characterized in that the data relevance value of the sensor (PIC 1, PIC 2) is applied to the bus (6) when a detected event occurs at the sensor (PIC 1, PIC 2) and/or on request from the control device (1) or from some other sensor (PIC 1, PIC 2).

3. The method as claimed in claim 1 or 2, characterized in that, following step c),
d) an ID value for the at least one sensor (PIC 1, PIC 2) is applied to the bus (6) and only a single most-relevant ID value is transmitted to the control device (1).

4. The method as claimed in claim 3, characterized in that steps a) to d) are repeated, with the sensor (PIC 1, PIC 2) whose ID value has in each case been transmitted not sending, until the values which are transmitted to the control device (1) are below a threshold value which can be predetermined.

5. A circuit arrangement for carrying out the method as claimed in one of the preceding claims, having a number of sensors (PIC 1, PIC 2), having a data bus (6) and having a control device (1) , characterized in that the sensors are connected via the data bus (6) to the control device (1) using the wired-AND principle, so that only one data item from one sensor (PIC 1, PIC 2) is passed through.

6. The circuit arrangement as claimed in claim 5, characterized in that the sensor (PIC 1, PIC 2) has a transmitting output (TX) and a receiving input (RX) which are connected to the bus (6) by means of access assemblers (3;5, 11;13, 17;19) and a monitoring device is provided which applies a neutral signal (logic “1”) to the transmitting output (TX) and to the receiving input (RX) when the signals differ.

7. The circuit arrangement as claimed in claim 5 or 6, characterized in that the bus (6) comprises only one logic data line.

8. The circuit arrangement as claimed in one of claims 5 to 7, characterized in that the bus (6) is “0”-dominant, “1”-dominant, or is wired-OR.

9. The circuit arrangement as claimed in one of claims 5 to 8, characterized in that the bus (6) is electrically in the form of a CAN bus.

10. The circuit arrangement as claimed in one of claims 5 to 9, characterized in that each sensor (PIC 1, PIC 2) has a unique ID value which can be transmitted to the control device (1).

11. The circuit arrangement as claimed in one of claims 5 to 10, characterized in that the control device (1) is designed to be RS232-compatible.
